(19) United States
(12) Patent Application Publication
(10) Pub. No.: US 2020/0380443 A1
(43) Pub. Date: Dec. 3, 2020

(54) DYNAMIC ORDERING OF TASKS IN A TASK SATURATED TIMELINE

(71) Applicant: HONEYWELL INTERNATIONAL INC., Morris Plains, NJ (US)

(72) Inventors: Barbara Holder, Seattle, WA (US); Stephen Whitlow, St. Louis Park, MN (US); Katarina Alexis Morowsky, Phoenix, AZ (US); Ivan Sandy Wyatt, Scottsdale, AZ (US)

(73) Assignee: HONEYWELL INTERNATIONAL INC., Morris Plains, NJ (US)

(21) Appl. No.: 16/423,649

(22) Filed: May 28, 2019

(51) Int. Cl. G06Q 10/06; G06N 20/00; B64D 45/00; G08G 5/00

(52) U.S. Cl. CPC G06Q 10/06316; G06Q 10/06312; G08G 5/003; B64D 45/00; G06N 20/00

(57) ABSTRACT

A system for ordering flight crew tasks during flight of an airborne vehicle is provided. The system includes one or more processors configured by programming instructions encoded on non-transient computer readable media. The system is configured to: retrieve a current ordering of a plurality of flight crew tasks across a flight profile and task context data; retrieve current flight data including: targets and constraints, progress and state of each required checklist, airspace dynamics information, environmental conditions, the time of day and year, and aircraft state information which includes the current automation and configuration state; retrieve airborne vehicle operator preferences; analyze the retrieved current ordering of flight crew tasks and task context data, current flight data, and operator preferences to predict a flight crew task saturation period; and re-order the current ordering of the plurality of flight crew tasks to reduce the occurrence of task saturation periods.

### TECHNICAL FIELD

Embodiments of the subject matter described herein relate generally to systems and methods for scheduling the performance of required flight crew tasks during a mission. More particularly, embodiments of the subject matter relate to systems and methods for dynamically adjusting the scheduling of required flight crew tasks during the mission.

### BACKGROUND

Checklists are tools used by aircraft flight crew to ensure that all required tasks are performed without omission and in an orderly manner. For a given mission, a number of different checklists may be utilized at different phases of flight. Each checklist includes flight crew tasks to be performed during the mission.

There may be times during the flight of an airborne vehicle (e.g., aircraft) when the flight crew has to perform a lot of tasks in a very short period of time, and there may be other times when the flight crew has very few tasks to perform. At times, the flight crew may be challenged to “create time” to allow for various tasks to be performed. To “create time” the flight crew may alter the parameters of a flight plan (e.g., slow down the aircraft or cause the aircraft to enter a holding pattern). Slowing down an aircraft or causing an aircraft to enter a holding pattern is generally not preferred because performing those techniques may be contrary to the desires of the aircraft operator (e.g., airline), which may be to reach a destination quickly or to minimize fuel usage. Thus, the flight crew may try to manage the scheduling of tasks as best as possible based on prior experience, which can increase the flight crew's workload.

Hence, it is desirable to provide a system and method for automatically managing the scheduling of tasks to balance flight crew workload, to minimize task saturation periods where pilot stress and the likelihood of pilot errors increase. Furthermore, other desirable features and characteristics of the present invention will become apparent from the subsequent detailed description and the appended claims, taken in conjunction with the accompanying drawings and the foregoing technical field and background.

### SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system for ordering flight crew tasks during flight of an airborne vehicle is provided. The system includes one or more processors configured by programming instructions encoded on non-transient computer readable media. The system is configured to: retrieve a current ordering of a plurality of flight crew tasks across a flight profile and task context data; retrieve current flight data including: targets and constraints, progress and state of each required checklist, airspace dynamics information, environmental conditions, the time of day and year, and aircraft state information which includes the current automation and configuration state; retrieve airborne vehicle operator preferences; analyze the retrieved current ordering of flight crew tasks and task context data, current flight data, and operator preferences to predict a flight crew task saturation period; and re-order the current ordering of the plurality of flight crew tasks to better balance workload across the flight, reducing the occurrence of task saturation periods.

A computer-implemented method for re-ordering the scheduling of flight crew tasks during flight to reduce the likelihood of high task saturation periods during a mission is provided. The method includes: retrieving a current, nominal ordering of flight crew tasks across a flight profile and task context data, current flight data, and aircraft operator preferences; analyzing the retrieved information and predicting whether a task saturated period may occur along the flight profile based on the analysis; and re-ordering the current ordering of flight crew tasks to reduce the occurrence of task saturated periods, when one or more task saturation periods have been predicted.

Furthermore, other desirable features and characteristics will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram depicting an example system that implements an example task scheduling engine (TSE) that is configured to re-order the scheduling of flight crew tasks during flight to reduce the likelihood of high task saturation periods during a mission, in accordance with some embodiments;

FIG. 2 is a process flow chart depicting an example process in a system, such as TSE, that is configured to evaluate current task ordering and re-order the scheduling of flight crew tasks during flight to reduce the likelihood of high task saturation periods during a mission, in accordance with some embodiments;

FIG. 3 is a process flow chart depicting an example process in a system for analyzing retrieved flight dynamics information and identifying task saturated periods along the flight profile based on the analysis, in accordance with some embodiments; and

FIG. 4 is a process flow chart depicting an example process in a system for re-ordering the nominal ordering of flight crew tasks to reduce the occurrence of task saturated periods, in accordance with some embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, methods, and articles for dynamically and automatically adjusting the scheduling of required flight crew tasks during the mission. Currently, the flight crew may use their best judgment regarding the timing and sequencing of tasks to ensure that all tasks are completed and safe flight operations are maintained. Examples of tasks that may need to be performed include tasks on various checklists, common procedures, and responses to changes to operational environment such as traffic and weather. Disclosed apparatus, systems, techniques, methods and articles can determine the density of tasks that are expected to be completed during specific time intervals. If the density of tasks exceeds a predetermined level, the disclosed system apparatus, systems, techniques, methods and articles can identify tasks that can be scheduled for performance earlier during the flight and recommend to the flight crew that one or more of the identified tasks be performed at an earlier time during the flight. Nominal task schedule for a given operator (e.g., airline) will constrain potential ordering such that the system would not recommend a task order that is counter to airline standard operating procedures (SOP). Disclosed apparatus, systems, techniques, methods and articles can consider all of the tasks that need to be performed and recommend a task sequencing and timing to ensure that all tasks are completed and to reduce the flight crew's workload.

Disclosed apparatus, systems, techniques, methods and articles can cause to be displayed to the flight crew in the aircraft a timeline that illustrates the task sequencing and timing of the re-ordered tasks. Disclosed apparatus, systems, techniques, methods and articles can map the tasks based on time and using software analytics detect when the task presence crosses a density threshold which would indicate a high likelihood that the flight crew would experience a time of task saturation. Disclosed apparatus, systems, techniques, methods and articles can identify the tasks that have the ability to be dynamically/flexibly scheduled and, when the task density threshold is exceeded, schedule the flexible tasks for performance at a time with a lower task density.

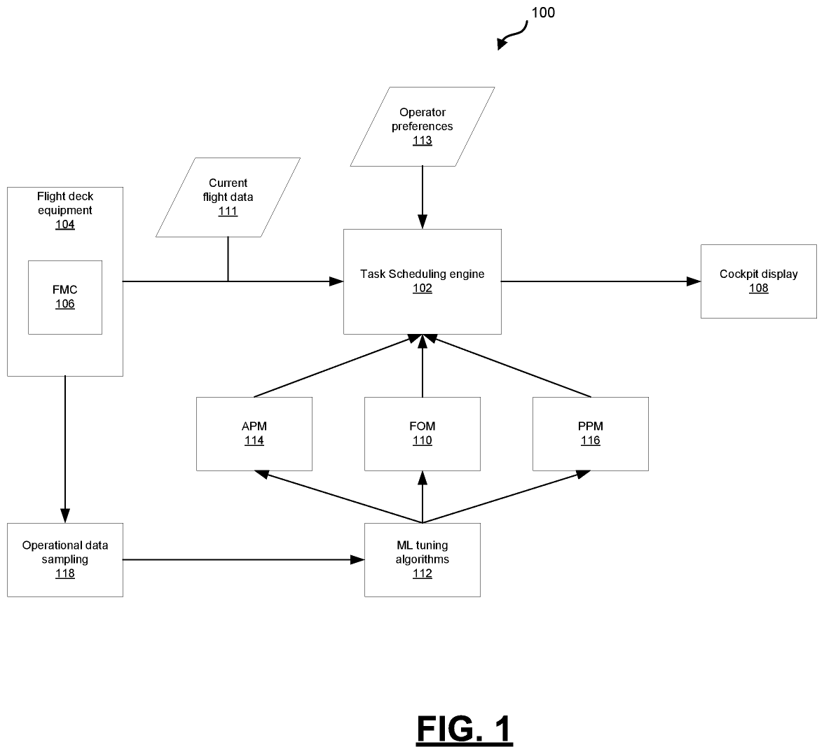

FIG. 1 is a block diagram depicting an example system 100 that implements an example task scheduling engine (TSE) 102 that is configured to re-order the scheduling of flight crew tasks during flight to reduce the likelihood of high task saturation periods during a mission. The example system 100 includes aircraft flight deck equipment 104, such as a flight management computer 106, the example TSE 102, and a cockpit display 108.

The example TSE 102 retrieves several dynamic inputs for use in predicting a future task saturated period and determining if it should recommend some tasks being performed sooner or later than originally planned. The example TSE 102 can execute continuously, periodically, or situationally based on the occurrence of one or more pre-determined events during the mission to analyze the dynamic inputs and adjust task scheduling based on conditions arising during flight. In addition, the example TSE 102 can consider one or more static models to determine whether tasks should be re-ordered. One such model includes a flight operational model (FOM) that provides a nominal ordering of pilot tasks across a flight profile, task priorities and serial dependencies between the tasks. The output of the example TSE 102 could include the following elements: suggestion to do a future task earlier; suggestion to do a future task later; suggestion to do a current task later; highlighting a predicted future task saturation period on a task timeline display displayed on the cockpit display 108; displaying proposed task re-ordering for flight crew review and/or approval on the cockpit display 108 such as on a timeline that shows the relative time at which certain tasks should be performed. Although the example TSE 102 is illustrated as residing onboard the aircraft, a TSE 102 could be implemented using a cloud-based platform wherein some or all of the processing is performed on the cloud-based platform.

In particular, the example TSE 102 is configured to retrieve a nominal ordering of flight crew tasks across a flight profile and task context data, retrieve current flight data 111, and retrieve aircraft operator preferences 113. The example TSE 102 is configured to analyze the retrieved information and predict task saturated periods along the flight profile based on the analysis. The example TSE 102 is further configured to re-order the nominal ordering of flight crew tasks to reduce the occurrence of task saturated periods.

The example TSE 102 is implemented by a controller. The controller includes at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller.

Regarding information retrieved by the example TSE 102, the task context data may include task priorities, serial dependencies between the tasks, and estimated times needed to complete tasks. The nominal ordering of flight crew tasks and task context data may be retrieved from a flight operational model (FOM) 110. The FOM 110 may be a static model for use during flight, but may be refined between use using a filtered dataset. As an example, the estimated times needed to complete tasks, retrieved from the FOM 110, initially may be based off expert estimates. The estimated times may be refined by applying machine learning techniques (e.g., derived from ML tuning algorithms 112) to a filtered dataset, wherein the filtered dataset is filtered for a specific aircraft type and destination airport.

The current flight data 111 may include information regarding targets and constraints from the flight management computer (FMC) 106, the progress and state of each required checklist, airspace dynamics information which may include traffic pattern and volume, environmental conditions such as wind and weather, the time of day and year, and aircraft state information which may include the current automation and configuration state. Examples of targets and constraints may include altitude and speed restrictions. Examples of required checklists may include before takeoff, after takeoff, climb, approach and before landing. Examples of current automation and configuration state may include autopilot engaged, auto-throttles engaged, localizer capture, glideslope captured, landing gear down, and others.

The operator preferences 113 may include operational priority information and pilot workload heuristics and rules. An example of operational priority information may include maintain serial order of certain high priority tasks. Examples of pilot workload heuristics and rules may include prohibitions against interrupting current checklist execution.

The example TSE 102 is configured to predict task saturated periods along the flight profile by assessing flight crew workload along the flight profile, determining flight crew task performance capacity at a plurality of points along the flight profile, and predicting a task saturated period when the flight crew workload is projected to exceed the flight crew task performance capacity.

When assessing flight crew workload, the example TSE 102 is configured to determine the expected timing of procedures. The expected timing of procedures may be determined from an aircraft performance model (APM) 114. The APM 114 may initially be set with expert determined values and the values may be refined using the application of machine learning techniques (e.g., derived from ML tuning algorithms 112) and collected aircraft procedure timing data. When assessing flight crew workload, the example TSE 102 may also be configured to assess flight crew workload along the flight profile using the refined times needed to complete tasks, which were determined from the FOM 110 and refined using machine learning techniques.

When re-ordering tasks, the example TSE 102 is configured to retrieve and consider pilot preferences for the ordering of tasks. The pilot preferences may be retrieved from a pilot preference model (PPM) 116. The PPM 116 may be a static model during use that is tunable in between missions using machine learning techniques (e.g., derived from ML tuning algorithms 112).

When re-ordering the nominal ordering of flight crew tasks, the example TSE 102 is configured to re-order the nominal ordering of flight crew tasks to not violate operational priorities and pilot workload heuristics and rules, and to minimize the occurrence of task saturation periods. To minimize the occurrence of task saturation periods, the example TSE 102 is configured to move one or more future tasks to an earlier time slot, move one or more future tasks to a later time slot, and/or move one or more current tasks to a later time slot.

The example TSE 102 is further configured to record operational data (e.g., via the use of operational data sampling 118) during a mission for use in tuning the FOM 110, APM 114, and PPM 116 using machine learning techniques. The example TSE 102 is configured to assist the flight crew with time and task management by balancing out workload more evenly across the flight to avoid task saturation where stress and high cognitive workload often lead to pilot errors. Furthermore, the example TSE 102 could provide operational value by avoiding situations where the flight crew “gets behind the aircraft” and are forced to “create time” by, for example, executing a missed approach and resulting go-around. Executing a missed-approach incurs greater fuel costs, delays the flight schedule, results in increased pilot workload and stress, and produces greater safety hazards.

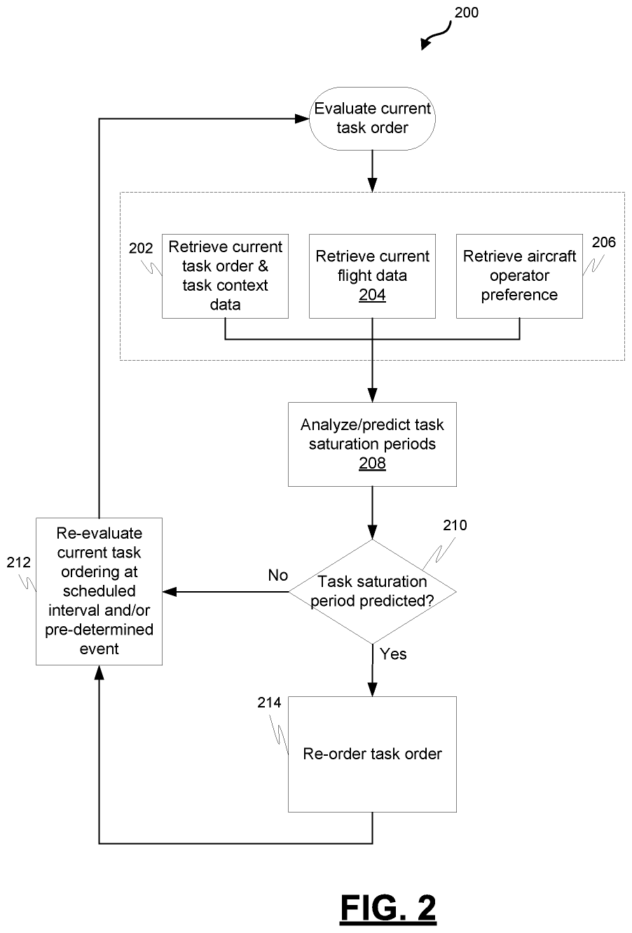

FIG. 2 is a process flow chart depicting an example process 200 in a system, such as TSE 102, that is configured to evaluate current task ordering and re-order the scheduling of flight crew tasks during flight to reduce the likelihood of high task saturation periods during a mission. The order of operation within the process 200 is not limited to the sequential execution as illustrated in the figure, but may be performed in one or more varying orders as applicable and in accordance with the present disclosure.

The example process 200 includes retrieving a nominal ordering of flight crew tasks across a flight profile and task context data (operation 202), retrieving current flight data (operation 204), and retrieving aircraft operator preferences (operation 206). The task context data may include task priorities, serial dependencies between the tasks, and estimated times needed to complete tasks. The current flight data may include information regarding targets and constraints from the flight management computer (FMC), progress and state of each required checklist; airspace dynamics information which may include traffic pattern and volume, environmental conditions such as wind and weather, the time of day and year, and aircraft state information which may include the current automation and configuration state. The operator preferences may include operational priority information and pilot workload heuristics and rules.

The example process 200 includes analyzing the retrieved information and predicting task saturated periods along the flight profile based on the analysis (operation 208). The example process 200 includes determining if a task saturation period has been predicted (decision 210).

If no task saturation period has been identified (no at decision 210), then the example process includes re-evaluating the current task ordering at a scheduled interval and/or predetermined event (operation 212). As an example, the re-evaluation may take place periodically, upon reaching a pre-determined waypoint, and/or upon detection of an environmental change, such as significant weather change, significant traffic change, equipment malfunction, air traffic control request, and other examples.

If one or more task saturation periods have been identified (yes at decision 210), then the example process includes re-ordering the nominal ordering of flight crew tasks to reduce the occurrence of task saturated periods (operation 214). The re-ordering may be accomplished by applying a scheduling algorithm configured to re-order the nominal ordering of flight crew tasks to reduce the occurrence of task saturated periods. After re-ordering the ordering of flight crew tasks, the example process may include re-evaluating the current task ordering at a scheduled interval and/or predetermined event (operation 212).

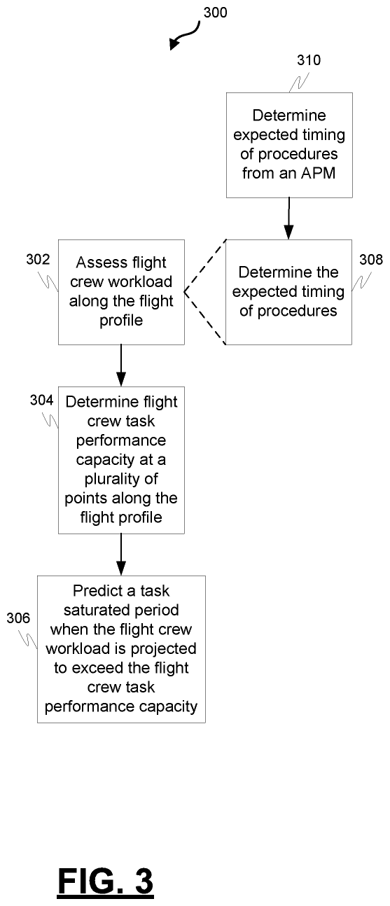

FIG. 3 is a process flow chart depicting an example process 300 in a system, such as TSE 102, for analyzing retrieved flight dynamics information (e.g., information retrieved from operations 202, 204, 206) and predicting task saturated periods along the flight profile based on the analysis. The order of operation within the process 300 is not limited to the sequential execution as illustrated in the figure, but may be performed in one or more varying orders as applicable and in accordance with the present disclosure.

The example process 300 includes assessing flight crew workload along the flight profile (operation 302), determining flight crew task performance capacity at a plurality of points along the flight profile (operation 304), and predicting a task saturated period when the flight crew workload is projected to exceed the flight crew task performance capacity (operation 306).

Assessing flight crew workload, may include determining the expected timing of procedures (operation 308). The expected timing of procedures may be determined from an aircraft performance model (operation 310).

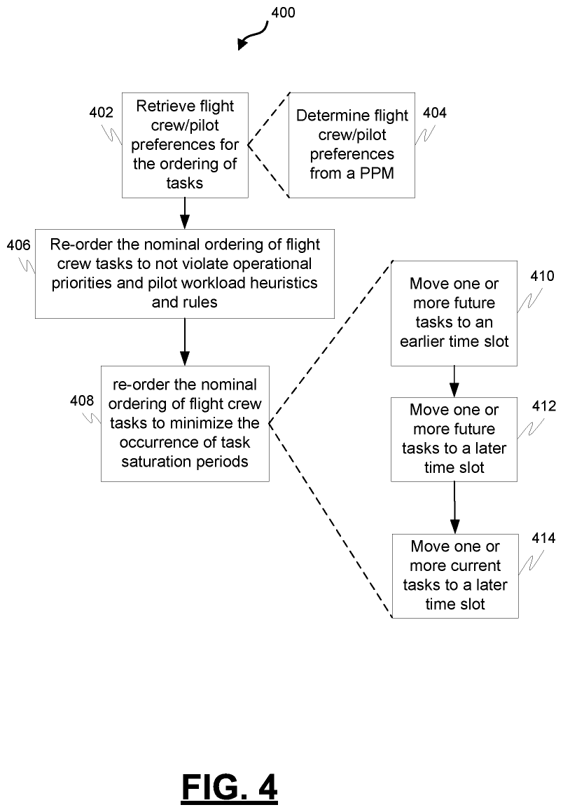

FIG. 4 is a process flow chart depicting an example process 400 in a system, such as TSE 102, for re-ordering the nominal ordering of flight crew tasks to reduce the occurrence of task saturated periods. The order of operation within the process 400 is not limited to the sequential execution as illustrated in the figure, but may be performed in one or more varying orders as applicable and in accordance with the present disclosure.

The example process 400 includes retrieving flight crew/pilot preferences for the ordering of tasks (operation 402). The flight crew/pilot preferences may be retrieved from a pilot preference model (PPM) (operation 404). The PPM may be a static model during mission use that is tunable in between missions using machine learning techniques.

The example process 400 includes re-ordering the nominal ordering of flight crew tasks to not violate operational priorities and pilot workload heuristics and rules (operation 406). Examples of operational priorities and pilot workload heuristics and rules include maintain serial order of certain high priority tasks, and prohibitions against interrupting current checklist execution.

The example process 400 includes re-ordering the nominal ordering of flight crew tasks to minimize the occurrence of task saturation periods (operation 408). To minimize the occurrence of task saturation periods, the example process 400 includes moving one or more future tasks to an earlier time slot (operation 410), moving one or more future tasks to a later time slot (operation 412), and/or moving one or more current tasks to a later time slot (operation 414).

Described herein are apparatus, systems, techniques and articles for dynamically and automatically adjusting the scheduling of required flight crew tasks during a mission.

In one embodiment, a system for ordering flight crew tasks during flight of an airborne vehicle is provided. The system comprises one or more processors configured by programming instructions encoded on non-transient computer readable media. The system is configured to: retrieve a current ordering of a plurality of flight crew tasks across a flight profile and task context data; retrieve current flight data including: targets and constraints, progress and state of each required checklist, airspace dynamics information, environmental conditions, the time of day and year, and aircraft state information which includes the current automation and configuration state; retrieve airborne vehicle operator preferences; analyze the retrieved current ordering of flight crew tasks and task context data, current flight data, and operator preferences to predict a flight crew task saturation period; and re-order the current ordering of the plurality of flight crew tasks to reduce the occurrence of task saturation periods.

These aspects and other embodiments may include one or more of the following features.

In one embodiment, the task context data comprises task priorities, serial dependencies between the tasks, and estimated times needed to complete tasks.

In one embodiment, the current ordering of flight crew tasks and task context data are retrieved from a flight operational model (FOM), wherein the FOM comprises a static model for use during flight that is configured to be refined between use by applying machine learning techniques and a filtered dataset.

In one embodiment, the filtered dataset is filtered for a specific aircraft type and destination airport.

In one embodiment, the airspace dynamics information comprises traffic pattern and volume and the environmental conditions comprise wind and weather.

In one embodiment, the airborne vehicle operator preferences comprises operational priority and pilot workload heuristics and rules.

In one embodiment, to predict a flight crew task saturation period, the system is configured to: assess flight crew workload along the flight profile; determine flight crew task performance capacity at a plurality of points along the flight profile; and predict a task saturated period when the flight crew workload is projected to exceed the flight crew task performance capacity.

In one embodiment, to assess flight crew workload, the system is configured to determine the expected timing of procedures from an aircraft performance model (APM).

In one embodiment, the APM comprises a static model for use during flight that is configured to be refined between use by applying machine learning techniques.

In one embodiment, to re-order the current ordering of the plurality of flight crew tasks, the system is configured to retrieve and consider pilot preferences for the ordering of tasks.

In one embodiment, the system is configured to determine the pilot preferences from a pilot preference model (PPM).

In one embodiment, the PPM comprises a static model for use during flight that is configured to be refined between use by applying machine learning techniques.

In one embodiment, to re-order the current ordering of the plurality of flight crew tasks, the system is configured to re-order the current ordering of flight crew tasks to not violate operational priorities and pilot workload heuristics.

In one embodiment, to reduce the occurrence of task saturation periods, the system is configured to move one or more future tasks to an earlier time slot, move one or more future tasks to a later time slot, and/or move one or more current tasks to a later time slot.

In another embodiment, a computer-implemented method for re-ordering the scheduling of flight crew tasks during flight to reduce the likelihood of high task saturation periods during a mission is provided. The method comprises: retrieving a current ordering of flight crew tasks across a flight profile and task context data, current flight data, and aircraft operator preferences; analyzing the retrieved information and predicting whether a task saturated period may occur along the flight profile based on the analysis; and re-ordering the current ordering of flight crew tasks to reduce the occurrence of task saturated periods, when one or more task saturation periods have been predicted.

These aspects and other embodiments may include one or more of the following features.

In one embodiment, the retrieving a current ordering of flight crew tasks across a flight profile and task context data comprises determining a current ordering of flight crew tasks and task context data from a flight operational model (FOM).

In one embodiment, the FOM comprises a static model for use during flight that is configured to be refined between use by applying machine learning techniques and a filtered dataset.

In one embodiment, the filtered dataset is filtered for a specific aircraft type and destination airport.

In one embodiment, the task context data comprises task priorities, serial dependencies between the tasks, and estimated times needed to complete tasks; the current flight data comprises information regarding targets and constraints from the flight management computer, progress and state of each required checklist, airspace dynamics information which includes traffic pattern and volume, environmental conditions including wind and weather, the time of day and year, and aircraft state information including the current automation and configuration state; and the operator preferences comprises operational priority information and pilot workload heuristics and rules.

In one embodiment, the analyzing the retrieved information and predicting comprises: assessing flight crew workload along the flight profile; determining flight crew task performance capacity at a plurality of points along the flight profile; and predicting a task saturated period when the flight crew workload is projected to exceed the flight crew task performance capacity.

In one embodiment, the assessing flight crew workload along the flight profile comprises determining the expected timing of procedures.

In one embodiment, the determining the expected timing of procedures comprises determining the expected timing of procedures from an aircraft performance model (APM).

In one embodiment, the APM comprises a static model for use during flight that is configured to be refined between use by applying machine learning techniques

In one embodiment, the re-ordering the current ordering of flight crew tasks to reduce the occurrence of task saturated periods comprises determining pilot preferences for the ordering of tasks.

In one embodiment, the determining pilot preferences for the ordering of tasks comprises determining pilot preferences for the ordering of tasks from a pilot preference model (PPM).

In one embodiment, the PPM comprises a static model for use during flight that is configured to be refined between use by applying machine learning techniques.

In one embodiment, the re-ordering the current ordering of flight crew tasks comprises re-ordering the current ordering of flight crew tasks to not violate operational priorities and pilot workload heuristics and rules.

In one embodiment, the re-ordering the current ordering of flight crew tasks to reduce the occurrence of task saturation periods comprises moving one or more future tasks to an earlier time slot, moving one or more future tasks to a later time slot, and/or moving one or more current tasks to a later time slot.

In one embodiment, the method further comprises recording operational data during missions for use in refining a flight operational model (FOM), an aircraft performance model (APM), and a pilot preference model (PPM) using machine learning techniques.

In another embodiment, a system for ordering flight crew tasks is provided. The system comprises one or more processors configured by programming instructions encoded on non-transient computer readable media. The system is configured to retrieve, from a flight operational model (FOM), a current ordering of a plurality of flight crew tasks across a flight profile including task priorities, serial dependencies between the tasks, and estimated times needed to complete tasks, wherein the estimated times needed to complete tasks are initially based off expert estimates, wherein the times needed to complete tasks are refined by applying machine learning techniques to a filtered dataset, and wherein the filtered dataset is filtered for a specific aircraft type and destination airport. The system is further configured to retrieve, for the current flight: targets and constraints from the flight management computer (FMC); progress and state of each required checklist; airspace dynamics information which include traffic pattern and volume, environmental conditions, and the time of day and year; and aircraft state information which includes the current automation and configuration state. The system is further configured to retrieve airline/operator preferences, such as operational priority and pilot workload heuristics and rules; assess flight crew workload along the flight profile using the refined times needed to complete tasks; determine flight crew task performance capacity at a plurality of points along the flight profile; identify task saturated periods along the flight profile; and re-order the current ordering of flight crew tasks. The system is configured to re-order the current ordering of flight crew tasks to: not violate operational priority and pilot workload heuristics and rules; and balance flight crew workload to minimize the occurrence of task saturation periods by moving one or more future tasks to an earlier time slot, moving one or more future tasks to a later time slot, and/or moving one or more current tasks to a later time slot.

In another embodiment, non-transient computer readable media encoded with programming instructions configurable to cause one or more processors to perform a method is provided. The method comprises: retrieving a current ordering of flight crew tasks across a flight profile and task context data, current flight data, and aircraft operator preferences; analyzing the retrieved information and predicting whether a task saturated period may occur along the flight profile based on the analysis; and re-ordering the current ordering of flight crew tasks to reduce the occurrence of task saturated periods, when one or more task saturation periods have been predicted.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for ordering flight crew tasks during flight of an airborne vehicle, the system comprising one or more processors configured by programming instructions encoded on non-transient computer readable media, the system configured to:
retrieve a current ordering of a plurality of flight crew tasks across a flight profile and task context data;
retrieve current flight data including: targets and constraints, progress and state of each required checklist, airspace dynamics information, environmental conditions, the time of day and year, and aircraft state information which includes the current automation and configuration state;
retrieve airborne vehicle operator preferences;
analyze the retrieved current ordering of flight crew tasks and task context data, current flight data, and operator preferences to predict a flight crew task saturation period; and
re-order the current ordering of the plurality of flight crew tasks to reduce the occurrence of task saturation periods.

2. The system of claim 1, wherein the task context data comprises task priorities, serial dependencies between the tasks, and estimated times needed to complete tasks.

3. The system of claim 1, wherein the current ordering of flight crew tasks and task context data are retrieved from a flight operational model (FOM), wherein the FOM comprises a static model for use during flight that is configured to be refined between use by applying machine learning techniques and a filtered dataset, wherein the filtered dataset is filtered for a specific aircraft type and destination airport.

4. The system of claim 1, wherein the airborne vehicle operator preferences comprises operational priority and pilot workload heuristics and rules.

5. The system of claim 1, wherein to predict a flight crew task saturation period, the system is configured to:
assess flight crew workload along the flight profile;
determine flight crew task performance capacity at a plurality of points along the flight profile; and
predict a task saturated period when the flight crew workload is projected to exceed the flight crew task performance capacity.

6. The system of claim 5, wherein to assess flight crew workload, the system is configured to determine the expected timing of procedures from an aircraft performance model (APM), that comprises a static model for use during flight that is configured to be refined between use by applying machine learning techniques.

7. The system of claim 1, wherein to re-order the current ordering of the plurality of flight crew tasks, the system is configured to retrieve and consider pilot preferences for the ordering of tasks from a pilot preference model (PPM), that comprises a static model for use during flight that is configured to be refined between use by applying machine learning techniques.

8. The system of claim 1, wherein to re-order the current ordering of the plurality of flight crew tasks, the system is configured to re-order the current ordering of flight crew tasks to not violate operational priorities and pilot workload heuristics.

9. The system of claim 1, wherein to reduce the occurrence of task saturation periods, the system is configured to move one or more future tasks to an earlier time slot, move one or more future tasks to a later time slot, and/or move one or more current tasks to a later time slot.

10. A computer-implemented method for re-ordering the scheduling of flight crew tasks during flight to reduce the likelihood of high task saturation periods during a mission, the method comprising:
retrieving a current ordering of flight crew tasks across a flight profile and task context data, current flight data, and aircraft operator preferences;
analyzing the retrieved information and predicting whether a task saturated period may occur along the flight profile based on the analysis; and
re-ordering the current ordering of flight crew tasks to reduce the occurrence of task saturated periods, when one or more task saturation periods have been predicted.

11. The method of claim 10, wherein the retrieving a current ordering of flight crew tasks across a flight profile and task context data comprises determining a current ordering of flight crew tasks and task context data from a flight operational model (FOM), that comprises a static model for use during flight that is configured to be refined between use by applying machine learning techniques and a filtered dataset, wherein the filtered dataset is filtered for a specific aircraft type and destination airport.

12. The method of claim 10, wherein:
the task context data comprises task priorities, serial dependencies between the tasks, and estimated times needed to complete tasks;
the current flight data comprises information regarding targets and constraints from the flight management computer, progress and state of each required checklist, airspace dynamics information which includes traffic pattern and volume, environmental conditions including wind and weather, the time of day and year, and aircraft state information including the current automation and configuration state; and
the operator preferences comprises operational priority information and pilot workload heuristics and rules.

13. The method of claim 10, wherein the analyzing the retrieved information and predicting comprises:
assessing flight crew workload along the flight profile;
determining flight crew task performance capacity at a plurality of points along the flight profile; and
predicting a task saturated period when the flight crew workload is projected to exceed the flight crew task performance capacity.

14. The method of claim 13, wherein the assessing flight crew workload along the flight profile comprises determining the expected timing of procedures from an aircraft performance model (APM), that comprises a static model for use during flight that is configured to be refined between use by applying machine learning techniques.

15. The method of claim 10, wherein the re-ordering the current ordering of flight crew tasks to reduce the occurrence of task saturated periods comprises determining pilot preferences for the ordering of tasks.

16. The method of claim 10, wherein the determining pilot preferences for the ordering of tasks comprises determining pilot preferences for the ordering of tasks from a pilot preference model (PPM), that comprises a static model for use during flight that is configured to be refined between use by applying machine learning techniques.

17. The method of claim 10, wherein the re-ordering the current ordering of flight crew tasks comprises re-ordering the current ordering of flight crew tasks to not violate operational priorities and pilot workload heuristics and rules.

18. The method of claim 10, wherein the re-ordering the current ordering of flight crew tasks to reduce the occurrence of task saturation periods comprises moving one or more future tasks to an earlier time slot, moving one or more future tasks to a later time slot, and/or moving one or more current tasks to a later time slot.

19. The method of claim 10 further comprising recording operational data during missions for use in refining a flight operational model (FOM), an aircraft performance model (APM), and a pilot preference model (PPM) using machine learning techniques.

20. Non-transient computer readable media encoded with programming instructions configurable to cause one or more processors to perform a method, the method comprising:
retrieving a current ordering of flight crew tasks across a flight profile and task context data, current flight data, and aircraft operator preferences;
analyzing the retrieved information and predicting whether a task saturated period may occur along the flight profile based on the analysis; and
re-ordering the current ordering of flight crew tasks to reduce the occurrence of task saturated periods, when one or more task saturation periods have been predicted.
